(19) United States
(12) Patent Application Publication
(10) Pub. No.: US 2022/0107199 A1
(43) Pub. Date: Apr. 7, 2022

(54) SEARCH DEVICE, SEARCH METHOD, AND STORAGE MEDIUM

(71) Applicant: HONDA MOTOR CO., LTD., Tokyo (JP)

(72) Inventor: Ryo Takebayashi, Tokyo (JP)

(21) Appl. No.: 17/488,464

(22) Filed: Sep. 29, 2021

(30) Foreign Application Priority Data
Oct. 1, 2020 (JP) 2020-167290

(51) Int. Cl. G01C 21/36; G01C 21/34

(52) U.S. Cl. CPC G01C 21/3617; G01C 21/3614; G01C 21/3476; G01C 21/3484

(57) ABSTRACT

A search device according to an embodiment includes: an acquirer configured to acquire a search request for searching for a place; and a searcher configured to search for a place on a map in a search range based on a preference of a user for the place relating to the search request.

### CROSS-REFERENCE TO RELATED APPLICATION

This application is based upon and claims the benefit of priority from Japanese Patent Application No. 2020-167290, filed Oct. 1, 2020, the entire contents of which is incorporated herein by reference.

### BACKGROUND

### Field of the Invention

The present invention relates to a search device, a search method, and a storage medium.

### Description of Related Art

There are technologies for setting a search range of points of interest (POI) in the vicinity of a vehicle in accordance with a traveling status of the vehicle, a road status, and the like (refer to Japanese Unexamined Patent Application, First Publication No. 2012-098128, for example).

### SUMMARY

However, there is a possibility of a change of search range using the related art reducing the convenience of a search. For example, even when a search range is expanded and more search results are acquired, in a case in which a user's interest in the area of the search range is low, most of the search results become useless, and there are cases in which visibility and operability are actually inhibited in accordance with such useless search results. In addition, depending on the traveling status of a vehicle, a road status, and the like, there are cases in which the search range is reduced more than necessary, and a necessary POI is not extracted.

The present invention is in consideration of such situations, and one object thereof is to provide a search device, a search method, and a storage medium capable of changing a search range on a map in accordance with a user's preference.

A search device, a search method, and a storage medium according to the present invention employ the following configurations.

(1) According to a first aspect of the present invention, there is provided a search device including: an acquirer configured to acquire a search request for searching for a place; and a searcher configured to search for a place on a map in a search range based on a preference of a user for the place relating to the search request.

(2) According to a second aspect of the present invention, in the first aspect, the place relating to the search request is a place on a movement path set by the user, and the search range is a range that has a place on a link configuring the movement path as its center and is based on a preference of the user for a district including the link.

(3) According to a third aspect of the present invention, in the first aspect, the place relating to the search request is a current location of the user or a specific location designated by the user, and the search range is a range that has the current location or the specific location as its center and is based on a preference of the user for the current location or the specific location.

(4) According to a fourth aspect of the present invention, in any one of the first aspect to the third aspect, the search device further includes a score information generator configured to generate score information that indicates the strength of the preference of the user for an administrative district on the basis of a relationship between a place represented on a map and the administrative district, and the searcher acquires the strength of the preference of the user for the administrative district having a target place relating to the search request on the basis of the score information and searches for the place on the map in the range of a search range that is a search range including the target place and has an area according to the strength of the preference.

(5) According to a fifth aspect of the present invention, in the fourth aspect, the score information generator analyzes the preference target of the user on the basis of a reviewing result of the preference for the user or behaviors performed by the user in the past and acquires the strength of the preference of the user for the administrative district on the basis of the relationship between the analyzed preference target and the administrative district.

(6) According to a sixth aspect of the present invention, in the fourth aspect or the fifth aspect, the searcher determines the search range on the basis of a first distance for setting a range that serves as a reference of the search range and a second distance for extending the range serving as the reference in accordance with the strength of the preferences.

(7) According to a seventh aspect of the present invention, in the sixth aspect, the searcher searches for a place on the map with a range to a distance acquired by summing the first distance and the second distance from the target place set as the search range.

(8) According to an eighth aspect of the present invention, in any one of the fourth aspect to the seventh aspect, the searcher extracts a place coinciding with a search condition relating to the search request in the search range among places represented on the map.

(9) According to a ninth aspect of the present invention, in any one of the fourth aspect to the eighth aspect, the score information generator determines a preference score of the user for an administrative district on the basis of nodes or edges passed through until a node corresponding to a certain administrative district is reached using the preference target of the user as a start point node in a graph structure representing a relationship between the preference target of the user and the administrative district.

(10) According to a tenth aspect of the present invention, there is provided a search method using a computer, the search method including: acquiring a search request for searching for a place; and searching for a place on a map in a search range based on a preference of a user for the place relating to the search request.

(11) According to an eleventh aspect of the present invention, there is provided a computer-readable non-transitory storage medium having a program stored thereon, the program causing a computer to execute: acquiring a search request for searching for a place; and searching for a place on a map in a search range based on a preference of a user for the place relating to the search request.

According to (1) to (3), (10), and (11), the search device searches for a place on the map in a search range based on the preference of the user for the place relating to the search request, whereby the search range on the map can be changed in accordance with the preference of the user.

According to (4) and (5), the search device acquires the strength of the preference of the user for an administrative district having the target place relating to the search request, whereby the search range relating to the target place can be set to a range according to the strength of the preference of the user for the administrative district having the target place.

According to (6) and (7), the search device determines the search range on the basis of the first distance for setting a range serving as a reference of the search range and the second distance for extending the range serving as the reference in accordance with the strength of the preference, whereby map information can be searched while the search range is expanded in correspondence with the strength of the preference using the range serving as the reference as a minimum.

According to (8), the search device extracts a place coinciding with the search condition relating to the search request in the search range among places represented on the map, whereby POIs coinciding with the preference of the user can be extracted from the search range having an area according to the preference of the user.

According to (9), the search device determines a preference score of the user for an administrative district on the basis of nodes or edges passed through until a node corresponding to a certain administrative district is reached using the preference target of the user as a start point node, whereby the relationship between the preference target and the administrative district can be defined using a graph structure that can be visually recognized easily.

### BRIEF DESCRIPTION OF THE DRAWINGS

FIG. 1 is a diagram illustrating an overview of a map information search system according to this embodiment.

FIG. 2 is a diagram illustrating an example of use of a map information search system according to this embodiment.

FIG. 3 is a block diagram illustrating an example of the configurations of a user terminal and a search device according to this embodiment.

FIG. 4A is a first example of user information according to this embodiment.

FIG. 4B is a second example of the user information according to this embodiment.

FIG. 4C is a third example of the user information according to this embodiment.

FIG. 5 is a flowchart illustrating an example of a process performed by a score information generator for generating score information in a search device according to this embodiment.

FIG. 6 is a diagram illustrating an example of correspondence information according to this embodiment.

FIG. 7 is a diagram illustrating an example of score information according to this embodiment.

FIG. 8 is a flowchart illustrating an example of a POI search process in which a search device searches for a POI on a map for a target user, and a result of the search is provided for a user terminal of the target user in a map information search system according to this embodiment.

FIG. 9 is a diagram illustrating an example of a search range of POIs determined for a target user by a search device in a map information search system according to this embodiment.

FIG. 10A is a diagram illustrating a first example of a search for map information in a case in which a search device according to this embodiment is configured as a part of a navigation device.

FIG. 10B is a diagram illustrating a second example of a search for map information in a case in which a search device according to this embodiment is configured as a part of a navigation device.

### DESCRIPTION OF EMBODIMENTS

Hereinafter, a search device, a search method, and a storage medium according to embodiments of the present invention will be described with reference to the drawings.

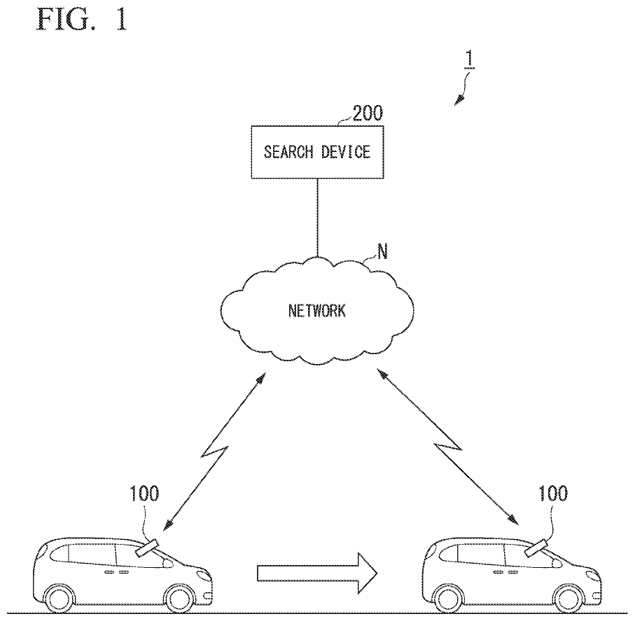

FIG. 1 is a diagram illustrating an overview of a map information search system 1 according to this embodiment. The map information search system 1 is a system that has a function of searching for a point of interest (POI) coinciding with a user's search condition from map information and providing a result of the search for the user (hereinafter referred to as a “map information search function”). Here, a POI represents a specific place represented on a map, and all objects that can be represented on a map such as a specific location, a district, a building, a mountain, a river, and a person can be configured as POIs. In order to provide such a map information search function, for example, the map information search system 1 includes a user terminal 100 and a search device 200. The user terminal 100 and the search device 200 are connected such that they are able to communicate with each other through a network N.

The user terminal 100 is a terminal device that is used by a user to use a map information provision function of the map information search system 1. For example, the user terminal 100 is a portable radio communication terminal such as a smartphone or a tablet and is connected to the network N through a radio communication line such as a cellular network. For example, an application performing transmission/reception of information about a map information search function to/from the search device 200 (hereinafter referred to as a “search application”) is installed in the user terminal 100. More specifically, the search application provides information required for a search for map information for the search device 200 as user information and acquires a result of a search for map information based on the provided user information from the search device 200.

The search device 200 is a device that performs a search for map information on the basis of user information provided from the user terminal 100 and provides a result of the search for the user terminal 100. More specifically, the search device 200 searches for map information within a search range set in accordance with a reference location of a user and extracts a POI coinciding with a predetermined search condition among POIs present within the search range. The reference location described here is an arbitrary location that is identified for a user.

For example, in a case in which the search device 200 provides the map information search function together with a route guiding function, the search device 200 may search for a POI near a root using a place on the guided route as a reference location. In addition, in such a case, the search device 200 may search for a POI present near a user using the current location of the user moving along a route as the reference location. For example, the search device 200 may search for a POI present near a specific place designated by a user.

In this way, although the reference location may be appropriately customized in accordance with a form in which the map information search function is provided by the search device 200 and the like, for simplification, the search device 200 will be described as searching for a POI present near a user for the user moving along a predetermined path in this embodiment. In order to realize such a function, the search device 200 according to this embodiment identifies a movement path of a user by continuously acquiring location information from the user terminal 100 and searches for a POI within a search range having the current location of the user terminal 100 as the reference location.

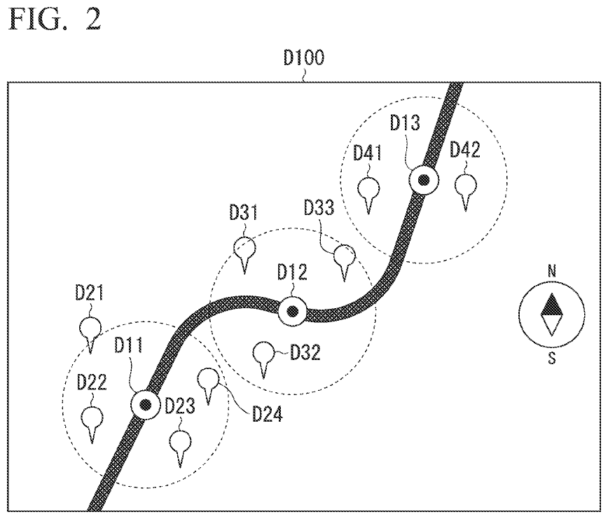

FIG. 2 is a diagram illustrating an example of use of the map information search system 1 according to this embodiment. A screen D100 illustrated in FIG. 2 is an example of a screen that displays a search result of POIs acquired using the map information search function on a map. For example, the screen D100 is displayed on a display of the user terminal 100 by a search application. The screen D100 illustrates a view in which the user terminal 100 is mounted in a vehicle traveling on a road RT1 and moves in a direction from a place D11 to a place D13 through a place D12. On the screen D100, icons D21 to D24 represent POIs retrieved within the range of a search range R11 having a place D11 as a reference location, icons D31 to D33 represent POIs retrieved within the range of a search range R12 having a place D12 as the reference location, and icons D41 and D42 represent POIs retrieved within the range of a search range R13 having a place D13 as the reference location. The example of FIG. 2 illustrates that the search range of POIs moves together with the user terminal 100, and the search result of POIs changes in accordance with the location of the user terminal 100 as well. In other words, the example of FIG. 2 illustrates that POIs coinciding with a search condition of a user are D21 to D24 at the place D11, are D31 to D33 at the place D12, and are D41 to D42 at the place D13.

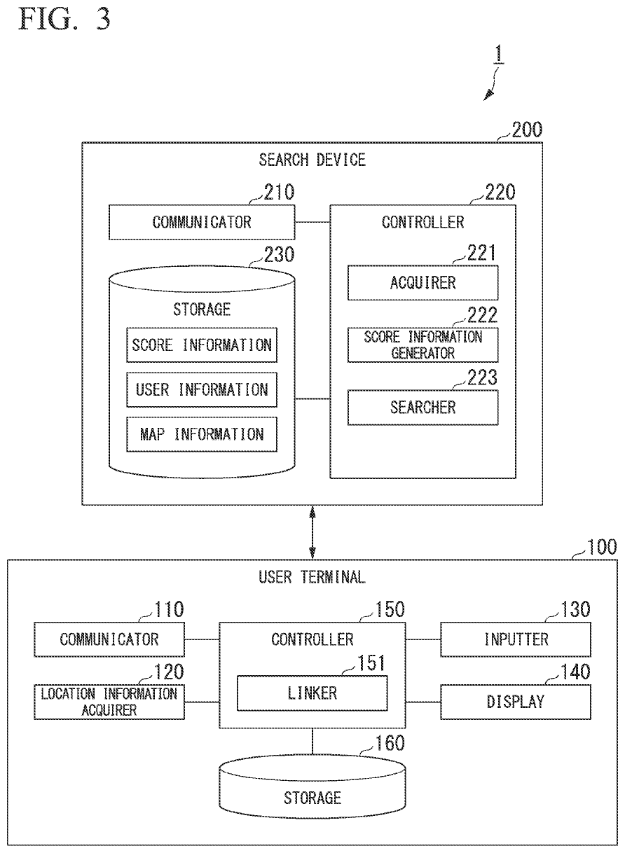

FIG. 3 is a block diagram illustrating an example of the configurations of the user terminal 100 and the search device 200 according to this embodiment. The user terminal 100 includes a communicator 110, a location information acquirer 120, an inputter 130, a display 140, a controller 150, and a storage 160. For example, such constituent elements are realized by a hardware processor such as a central processing unit (CPU) executing a program (software). Some or all of these constituent elements may be realized using hardware (a circuit; including circuitry) such as a large scale integration (LSI), an application specific integrated circuit (ASIC), a field-programmable gate array (FPGA), or a graphics processing unit (GPU) or may be realized using software and hardware in cooperation. The program may be stored in a storage device (a storage device including a non-transitory storage medium) such as a hard disk drive (HDD) or a flash memory in advance or may be stored in a storage medium (a non-transitory storage medium) that can be loaded or unloaded such as a DVD or a CD-ROM and installed by loading the storage medium into a drive device.

The communicator 110 is a radio communication interface used for connecting the user terminal 100 to the network N. For example, the communicator 110 is wirelessly connected to a base station such as a cellular network and is connected to the network N through the base station. The communicator 110 communicates with the search device 200 through the network N.

The location information acquirer 120 acquires location information of the user terminal 100. For example, the location information acquirer 120 is a Global Positioning System (GPS) sensor. The location information acquirer 120 outputs the acquired location information to the controller 150.

For example, the inputter 130 is configured using an input device such as a keyboard, a mouse, or a touch panel. The inputter 130 accepts inputs of various operations to the user terminal 100. The inputter 130 outputs input information to the controller 150.

For example, the display 140 is configured using a display device such as a liquid crystal display or an organic electro-luminescence display. The display 140 displays various kinds of information output from the controller 150. In addition, the display 140 may be configured integrally with the inputter 130 using a touch panel.

The controller 150 controls the operation of the user terminal 100. More specifically, the controller 150 includes a linker 151 that realizes a linking function for the search device 200 in addition to having a function of controlling input/output to/from the communicator 110, the location information acquirer 120, the inputter 130, the display 140, and the storage 160. For example, the linker 151 is realized by executing a search application.

More specifically, the linker 151 has a function of transmitting user information to the search device 200. For example, in a case in which a POI search request is input to the user terminal 100, the linker 151 transmits user information representing the search request to the search device 200. In addition, the linker 151 transmits location information of the user terminal 100 as user information. In addition, for example, the linker 151 may transmit a part of the map information search condition to the search device 200 by including it in the user information in addition to the location information.

For example, in a case in which the search device 200 provides a map information search function in combination with another function such as route guiding, the linker 151 may transmit input information for such another function and the like to the search device 200 by including it in the user information. For example, the linker 151 may transmit information such as a movement means and movement conditions, a start place, a destination, and a movement time to the search device 200 by including it in the user information.

On the other hand, the linker 151 has a function of receiving a result of the search of map information performed on the basis of the transmitted user information from the search device 200 and notifying a user of the received result of the search. For example, the linker 151 causes the display 140 to display the result of the search acquired from the search device 200.

For example, the storage 160 is configured using a magnetic storage device such as a hard disk drive (HDD) or a semiconductor storage device such as a solid state drive (SSD). The storage 160 stores various kinds of information about the operation of the user terminal 100. For example, a program of a search application is stored in the storage 160. In addition, for example, location information acquired by the location information acquirer 120, information representing a result of the search of map information acquired from the search device 200, and the like may be stored in the storage 160.

Next, the configuration of the search device 200 will be described. The search device 200 includes a communicator 210, a controller 220, and a storage 230. For example, such constituent elements are realized by a hardware processor such as a CPU executing a program (software). Some or all of such constituent elements may be realized by hardware (a circuit; including circuitry) such as a LSI, an ASIC, a FPGA, or a GPU or may be realized by software and hardware in cooperation. The program may be stored in a storage device (a storage device including a non-transitory storage medium) such as a hard disk drive (HDD) or a flash memory in advance or may be stored in a storage medium (a non-transitory storage medium) that can be loaded or unloaded such as a DVD or a CD-ROM and installed by loading the storage medium into a drive device.

The communicator 210 is a communication interface used for connecting the search device 200 to the network N. The communicator 210 may be a radio communication interface or a wired communication interface. The communicator 210 communicates with the user terminal 100 through the network N.

The controller 220 controls the operation of the search device 200. More specifically, the controller 220 includes an acquirer 221, a score information generator 222, and a searcher 223 as components used for realizing the linking function for the user terminal 100 in addition to having a function of controlling input/output to/from the communicator 210 and the storage 230.

The acquirer 221 has a function of acquiring user information from the user terminal 100 of each user and recording the acquired user information in the storage 230. More specifically, the acquirer 221 records identification information of each user in the storage 230 in association with the user information acquired from each user terminal 100.

The score information generator 222 has a function of generating score information of each user on the basis of the user information. Here, the score information is information that represents an index value indicating strength of a user's preference (hereinafter referred to as a “preference score”) for each administrative district such as a city, a town, and a village. A method for acquiring a preference score on the basis of the user information will be described below.

The searcher 223 has a function of searching for POIs on a map within a search range according to the current location of a user. Although the search range does not necessarily include the current location of a user as described above, in this embodiment, for a user moving along a predetermined path, the search device 200 searches for POIs present near the user, and thus the search range according to this embodiment is a range that includes the current location of the user and has an area according to a preference score of the user.

More specifically, the searcher 223 identifies an administrative district in which a user is currently located on the basis of location information acquired from the user terminal 100 and acquires a preference score of the user for the administrative district on the basis of the identified administrative district and the score information. The searcher 223 sets a search range in accordance with the acquired preference score and searches for POIs coinciding with the search condition within the search range. The searcher 223 provides a result of the search acquired in this way for the user terminal 100.

The storage 230, for example, is configured using a magnetic storage device such as an HDD or a semiconductor storage device such as an SSD. The storage 230 stores various kinds of information about the operation of the search device 200. For example, the storage 230 stores map information, score information, and user information. For example, the map information is information in which location information of each of various POIs is associated with image information representing the POI. For example, in addition to objects relating to road traffics such as a road for each section (hereinafter referred to as a “road link”), intersections, and toll gates, all objects that can be represented on a map such as buildings, apartments, various stores, bridges, mountains, and rivers are included as POIs in the map information. In addition, information representing attributes of each POI may be included in the map information. For example, attribute information of each POI about a road such as a type and a boundary of a lane, a curvature of the road, and the like and attribute information of various facilities such as address information (an address and a postal code) and a telephone number information may be included in the map information. In addition, road information, traffic regulation information, and the like may be included in the map information. The map information may be updated as required by the search device 200 communicating with other devices.

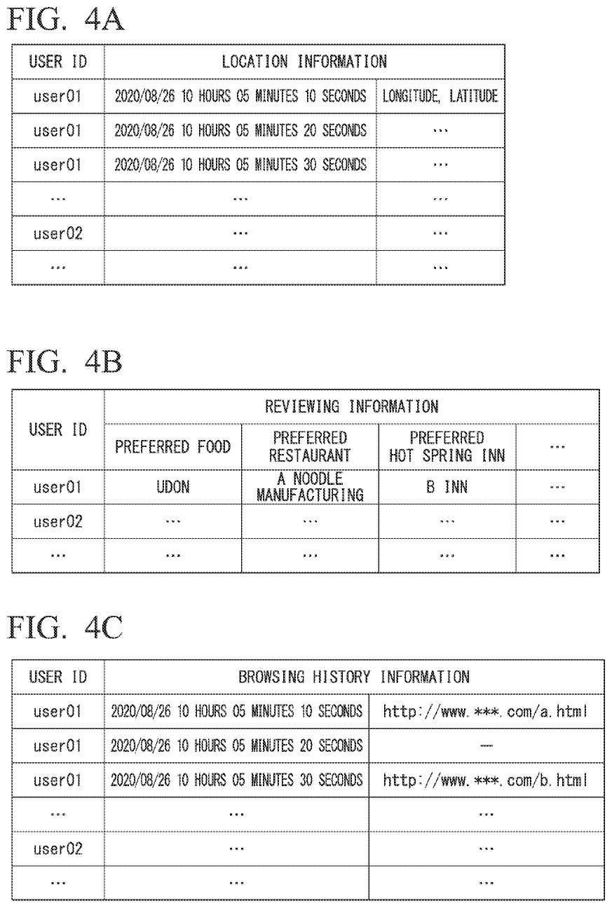

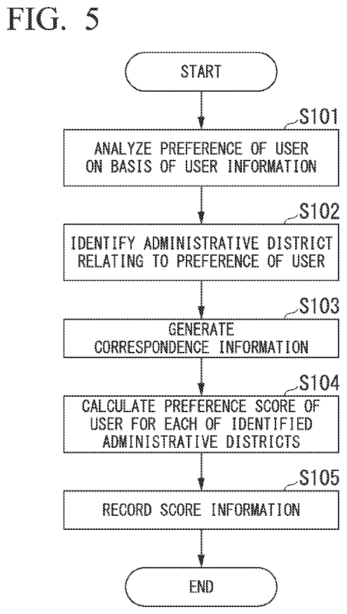

FIG. 4A is a first example of user information according to this embodiment. For example, FIG. 4A illustrates an example in which a user ID that is identification information of a user is associated with the user information including location information. In addition, FIG. 4B is a second example of the user information according to this embodiment. For example, FIG. 4B illustrates an example in which a user ID is associated with the user information including reviewing (hearing) information. Furthermore, FIG. 4C is a third example of the user information according to this embodiment. For example, FIG. 4C illustrates an example in which a user ID is associated with the user information including browsing history information. Here, the reviewing information is information that represents reply details of a user to a reviewing for a preference. In addition, the browsing history information is information that represents web sites browsed by a user using the user terminal 100. The user ID may be acquired from each user terminal 100 as user information or may be assigned when the acquirer 221 acquires user information from each user terminal 100. Such user information is an example of information used for acquiring a user's preference in a score information generation process illustrated in the next FIG. 5.

FIG. 5 is a flowchart illustrating an example of a process performed by the score information generator 222 for generating score information in the search device 200 according to this embodiment. First, the score information generator 222 analyzes preferences of each user on the basis of the user information of each user accumulated in the storage 230 (Step S101). The preference of a user described here may be any item that can be associated with one administrative district.

For example, the score information generator 222 can acquire preferences of a user on the basis of reviewing information acquired as the user information. For example, in the example of the reviewing information illustrated in FIG. 4B, for a user identified by a user ID “user01,” it is analyzed that a favorite food is “udon,” a favorite restaurant is “A noodle manufacturing,” and a favorite hot spring inn is “B inn.” For example, the score information generator 222 can acquire preferences of a user on the basis of browsing history information acquired as the user information. For example, the score information generator 222 accesses web sites browsed by a user and can analyze items described at the web sites as preferences of the user. In addition, for example, the score information generator 222 can acquire preferences of a user on the basis of location information acquired as the user information. For example, the score information generator 222 can estimate POIs that a user has visited on the basis of a history of location information and analyze such POIs as preferences of the user. Such an analysis method is one example, and the method for analyzing preferences of a user is not limited to such a method. For example, the score information generator 222 may analyze preferences of a user on the basis of another behavior history in place of the location information or the browsing history information.

Subsequently, the score information generator 222 identifies an administrative district relating to the preferences of the user acquired in Step S101 (Step S102). For example, the score information generator 222 can determine presence/absence of a relationship between an administrative district and preferences of a user on the basis of dictionary data relating to administrative districts and preferences of users. For example, an electronic version of a book (for example, an encyclopedia or the like) introducing preference targets of users and administrative districts or the like, download data of an online encyclopedia such as Wikipedia (a registered trademark), or the like can be used as dictionary data. The dictionary data is assumed to be stored in the storage 230 or the like in advance. The score information generator 222 generates correspondence information in which a preference of a user and an administrative district relating thereto are associated with each other on the basis of a result of the determination of the relationship based on the dictionary data in this way (Step S103). The score information generator 222 records the generated correspondence information in the storage 230.

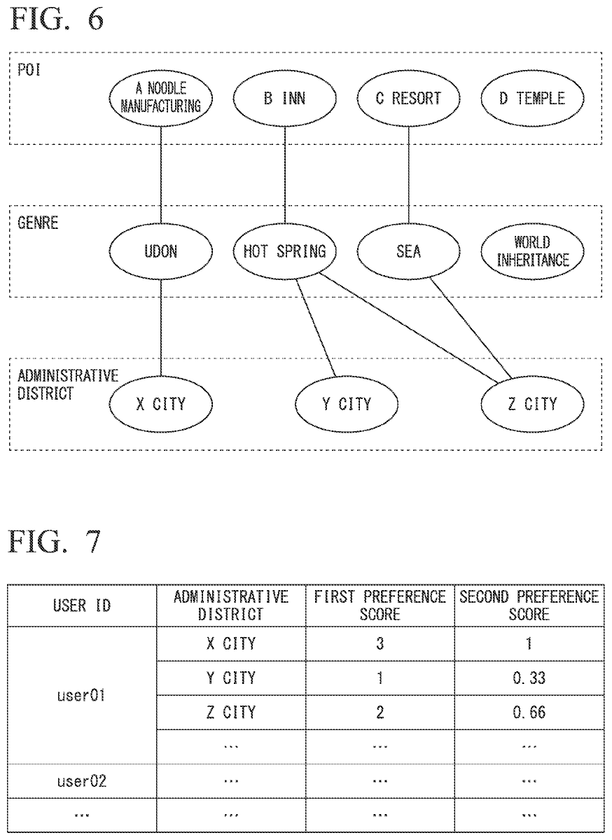

FIG. 6 is a diagram illustrating an example of the correspondence information according to this embodiment. For example, FIG. 6 is an example of the correspondence information generated by associating each genre with one administrative district with a preference target that may become a POI being associated with a relating genre among preference targets of users that have been analyzed. For example, in the example illustrated in FIG. 6, an administrative district “X city” is associated with a genre “udon” with which a POI of a restaurant “A noodle manufacturing” providing an udon dish is associated. In other words, the correspondence information illustrated in FIG. 6 is an example in which a POI and an administrative district are associated with each other through a genre to which the POI belongs. In this meaning, the analysis of preferences in Step S101 can be described as analysis of a POI or a genre that is preferred by a user. A genre may be generated by classifying a preference target that may become a POI or may be analyzed as a preference of a user.

The score information generator 222 calculates a preference score of each user for each administrative district on the basis of the correspondence information of each user generated in this way (Step S104). Here, several specific examples of a method for acquiring a preference score of a user for each administrative district will be described using the example of the correspondence information illustrated in FIG. 6.

For example, the score information generator 222 identifies an administrative district relating to one POI or genre included in the correspondence information as a start point, and for each identified administrative district, calculates a numerical value calculated on the basis of the POI, the genre, or the administrative district relating to the identifying or a correspondence relation thereof and the like as a preference score of a user for each administrative district.

For example, a case will be considered in which each of POIs of “A noodle manufacturing,” “B inn,” and “C resort” is given as a preference target of a user for the correspondence information of the example illustrated in FIG. 6. In this case, the score information generator 222 identifies “udon” connected to “A noodle manufacturing” as a genre preferred by a user and identifies “Y city” and “Z city” connected to the identified genre “udon” as administrative districts matching a user's preference (hereinafter referred to as “matched districts”). In this case, for example, the score information generator 222 adds 1 to the score of “X city” that is one of the identified districts.

Similarly, the score information generator 222 adds 1 to each of scores of the administrative districts “Y city” and “Z city” identified through a genre “hot spring” connected to “B inn.” Similarly, the score information generator 222 adds 1 to the score of the administrative district “Z city” identified through a genre “sea” connected to “C resort.” The score information generator 222 can acquire the value of each score calculated as a result of such additions as a preference score of a user for each administrative district. In other words, in a case in which “A noodle manufacturing,” “B inn,” and “C resort” are given as preference targets of a user for the correspondence information of the example illustrated in FIGS. 6, 1, 1, and 2 (=1+1) are respectively calculated as values of the preference scores of “X city,” “Y city,” and “Z city.”

Although a case in which the same value (1 in the example described above) is added to each of the scores of administrative districts identified for one preference target has been described here, this is one example of the method for calculating values of scores, and the score addition method may be set on the basis of an arbitrary idea. For example, in a case in which a plurality of administrative districts are identified for one preference target, the score information generator 222 may add proportionally divided values to scores such that a total sum of the values added to the scores of the administrative districts becomes 1. For example, in a case in which “A noodle manufacturing,” “B inn,” and “C resort” are given as preference targets of a user for the correspondence information of the example illustrated in FIGS. 6, 1, 0.5, and 1.5 (=0.5+1) are respectively calculated as values of the preference scores of “X city,” “Y city,” and “Z city.”

Although a case in which reachable administrative districts are identified as matched districts with a POI preferred by a user used as a start point has been described here, this is one example of the method for identifying matched districts, and the method for identifying matched districts may use a preference target other than a POI as a start point as long as the preference target can be directly or indirectly associated with administrative districts. For example, in the example illustrated in FIG. 6, the score information generator 222 may identify matched districts using not a POI but a genre as a start point. For example, in a case in which genres “udon,” “hot spring,” and “sea” are given as preference targets of a user for the correspondence information of the example illustrated in FIG. 6, the score information generator 222 adds 1 to the score of “X city” connected to “udon,” adds 1 to the scores of “Y city” and “Z city” connected to “hot spring,” and adds 1 to the score of “Z city” connected to “sea.” As a result, 1, 1, and 2 (=1+1) are respectively calculated as values of the preference scores of “X city,” “Y city,” and “Z city” in this case.

In addition, new nodes (hereinafter, referred to as “child nodes”) may be associated with administrative districts or POIs in the correspondence information. A node described here represents each of the POI, the genre, and the administrative district in a case in which the correspondence relation illustrated in FIG. 6 is regarded as a graph structure, and, hereinafter, each connection between nodes will be referred to as an edge. In this case, the score information generator 222 may identify reachable administrative districts with such a child node as a start point as matched districts.

In addition, for example, the score information generator 222 may add values according to distances from a preference target of a user serving as a start point to administrative districts that are matched districts to the scores. A distance described here can be regarded as, for example, the number of edges passed through until a matched district is reached from a node serving as a start point. For example, in a case in which a POI “A noodle manufacturing” and a genre “Hot spring” are given as preference targets of a user for the correspondence information of the example illustrated in FIG. 6, the score information generator 222 adds 2, which is the number of edges, to the score of “X city” identified using “A noodle manufacturing” as a start point and adds 1, which is the number of edges,” to the scores of “Y city” and “Z city” identified using “Hot spring” as a start point. As a result, 2, 1, and 1 are respectively calculated as values of the preference scores of “X city”, “Y city”, and “Z city” in this case. A distance described here may be represented by the number of passing nodes in place of the number of passing edges.

In addition, for example, the score information generator 222 may add a value according to a path until an administrative district that is a matched district is reached from a preference target of a user that serves as a start point to a score. For example, the score information generator 222 may add a total sum of numerical values set to nodes (or edges) that are passed through until matched districts are reached from the preference target to the score. In this case, the same numerical value may be set to each node, a numerical value according to attributes of each node may be set to each node, or a coefficient used for correcting a preset value in accordance with attributes of each node may be set to each node. For example, a numerical value according to a data source of an attribute value (a value representing an attribute of a POI, a genre, an administrative district, or the like (for example, “A noodle manufacturing”, “udon”, or the like)) may be set to each node. In addition, for example, a coefficient used for correcting a preset value in accordance with estimation accuracy of an attribute value may be set to a node of which the attribute value is acquired through estimation.

For example, based on an idea that an attribute value acquired through reviewing more directly indicates a preference of a user, a larger numerical value may be considered to be set to such an attribute value. In addition, for example, an attribute value estimated on the basis of a history of location information of a user is merely an estimated value, and thus a smaller numerical value may be considered to be set to such an attribute value. In addition, based on an idea that an attribute value acquired on the basis of a browsing history of web sites indicates a preference of a user not directly as an attribute value acquired through reviewing but more directly than an attribute value estimated on the basis of location information, a numerical value of an intermediate degree may be considered to be set to such an attribute value.

For example, in the correspondence information of the example illustrated in FIG. 6, in a case in which the genre “udon” is an attribute value acquired through reviewing, the POI “B inn” is an attribute value estimated on the basis of a history of location information of a user, and administrative districts “X city” and “Y city” are attribute values acquired on the basis of a browsing history of web sites, numerical values 3, 1, 2, and 2 are considered to be respectively set to the nodes of “udon”, “B inn”, “X city”, and “Y city”. Here, in a case in which 0 is set to numerical values of nodes other than “udon”, “B inn”, “X city”, and “Y city”, and “udon” and “B inn” are given as preference targets of a user, the score information generator 222 can calculate 5 (=3+2), 3=(1+2), and 1 respectively as values of preference scores of “X city”, “Y city”, and “Z city”.

The score information generator 222 records information representing a preference score for each user calculated for each administrative district in the storage 230 as score information in this way (Step S105).

FIG. 7 is a diagram illustrating an example of the score information according to this embodiment. For example, as illustrated in FIG. 7, the score information is stored in the storage 230 in a form of a table in which each record includes values of a user ID, an administrative district, a first preference score, and a second preference score. Here, the user ID is identification information of each user. The first preference score represents a preference score of a user for an administrative district, and the second preference score represents a normalized preference score. The normalization described here represents that values of preference scores of administrative districts are proportionally converted with a maximum value thereof set as 1. In addition, a preference score may be set to zero for administrative districts that are not identified as matched districts.

For example, in the example of the score information illustrated in FIG. 7, the first preference scores of a user identified by user ID “user0l” are respectively 3, 1, and 2 for “X city”, “Y city”, and “Z city”. In this case, by proportionally converting the values of the first preference scores such that 3, which is a maximum value thereof, is converted into 1, the score information generator 222 can respectively acquire 1, 0.33, and 0.66 as the second preference scores of “X city”, “Y city”, and “Z city”. In this way, by converting (in other words, normalizing) the first preference scores into the second preference scores, the preference score of a matched district of each user can be configured to be a value in the range of 0 to 1.

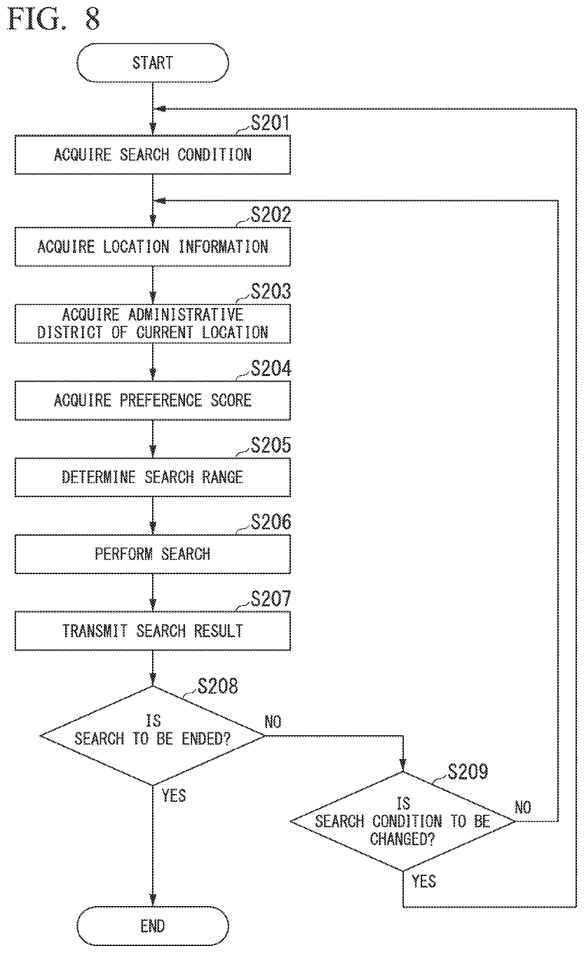

FIG. 8 is a flowchart illustrating an example of a process in which the search device 200 searches for POIs on a map for a user of a search target (hereinafter, referred to as a “target user”) and provides a result of the search for the user terminal 100 of the target user (hereinafter, referred to as a “POI search process) in the map information search system 1 according to this embodiment. First, in the search device 200, the acquirer 221 acquires a POI search condition (Step S201). For example, the search condition may be acquired from the user terminal 100 as user information or may be acquired on the basis of the correspondence information registered in advance for the target user. The acquirer 221 notifies the searcher 223 of the acquired search condition. Subsequently, the acquirer 221 acquires user information including location information from the user terminal 100 of the target user (Step S202). The acquirer 221 outputs the acquired location information of the user terminal 100 to the searcher 223.

Subsequently, the searcher 223 identifies the current location of the target user on the basis of the location information of the user terminal 100 acquired from the acquirer 221 and acquires an administrative district of a place in which the target user is current located (hereinafter, referred to as a “current administrative district) on the basis of the identified current location of the target user and the map information (Step S203). Next, the searcher 223 acquires a preference score for the current administrative district of the target user on the basis of the current administrative district and the score information acquired for the target user (Step S204).

Next, the searcher 223 sets a reference location on the basis of the current location of the target user and determines a search range for POIs on the basis of the reference location and the preference score for the current administrative district determined for the target user (Step S205). The searcher 223 performs a search for POIs within the determined search range (Step S206). More specifically, the searcher 223 determines a search condition for POIs present within the search range and transmits POIs coinciding the search condition to the user terminal 100 as a result of the search (Step S207).

For example, the searcher 223 can determine the search range for POIs by calculating a distance y from the reference location using the following Equation (1) having a preference score x as its variable.

y=ax+b (1)

In Equation (1), a represents a distance that is a reference for expanding the search range in accordance with the preference score x (hereinafter, referred to as a “reference distance), and b represents a distance used for setting a minimum search range (hereinafter, referred to as a “minimum distance”). Here, the second preference score illustrated in FIG. 6 takes a value in the range of 0 to 1 in accordance with normalization, and thus, by applying the second preference score to the preference score x, the distance y can be set in the range of b to a+b. In other words, in a case in which the preference score x of a user is zero (the user has no interest), y=b, and for such an administrative district, the search range can be set to be in a range to the distance b from the reference location. On the other hand, in a case in which the preference score x of the user takes a maximum value (the user has a maximum interest) (for example, 1 in the example illustrated in FIG. 6), y=a+b, and for such an administrative district, the search range can be set to be in a range to a distance a+b from the reference location.

In addition, in this case, the search range includes the reference location and does not necessarily need to be a circle of the distance y having the reference location as its center as long as it is a range of which a shape and a size are determined on the basis of the distance y. For example, the search range may be a polynomial having a diagonal line of the length y that has the reference location as its center or may be a polynomial having a length of one side as y and having the reference location as its center.

Subsequently, the searcher 223 determines whether or not a POI search end condition is satisfied (Step S208). For example, the POI search end condition may be a condition of the user arriving at the destination, a condition of the user performing an operation of ending a POI search on the user terminal 100, a condition of a predetermined period set in advance expiring, or any other condition.

Here, in a case in which it is determined that the POI search end condition is not satisfied, the searcher 223 determines whether or not the search condition is to be changed (Step S209). For example, by displaying a user interface for accepting an input of an operation of changing the search condition on the user terminal 100 and acquiring input information of a target user for the user interface from the user terminal 100, the searcher 223 can determine whether or not the search condition is to be changed.

Here, in a case in which it is determined that the search condition for POIs is to be changed, the searcher 223 returns the process to Step S101, acquires user information representing a new search condition from the user terminal 100, and then repeatedly performs the process of Step S202 and subsequent steps. On the other hand, in a case in which it is determined that the search condition for POIs is not to be changed in Step S209, the searcher 223 returns the process to Step S202 and repeatedly performs the process of Step S202 and subsequent steps using the same search condition as that of the previous time.

On the other hand, in a case in which it is determined that the POI search end condition is satisfied in Step S208, the searcher 223 ends a series of POI search processes. By performing such POI search processes, the search device 200 can change the search range for POIs in accordance with the preference of a user, and the convenience of the POI search function can be improved.

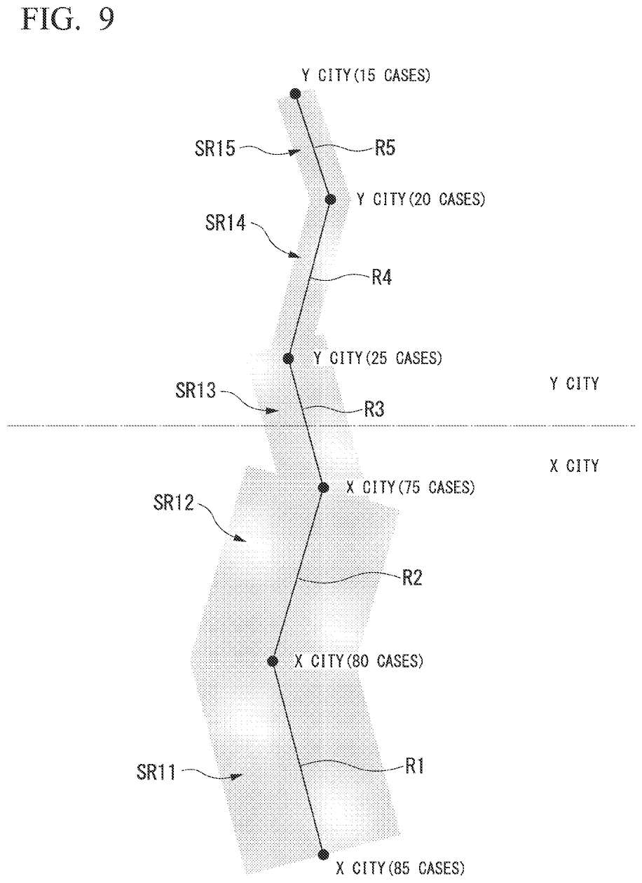

FIG. 9 is a diagram illustrating an example of a search range of POIs determined for a user by the search device 200 in the map information search system 1 according to this embodiment. This example illustrates a search range that is set when a user whose preference score for “X city” is higher than a preference score for “Y city” (in other words, the preference for “X city” is stronger than the preference for “Y city”) is moving from “X city” to “Y city”. In FIGS. 9, R1 to R5 represent sections of a road partitioned using a predetermined reference (hereinafter, referred to as links). R1 and R2 are links in the X city, and R4 and R5 are links in the Y city. In addition, R3 is a link that extends over a boundary between the X city and the Y city (a dashed line in the drawing).

In this case, the preference score for the X city is higher than the preference score for the Y city, and thus search ranges SR11 and SR12 for POIs in links in the X city are set to be larger than search ranges SR14 and SR15 for POIs in a road section in the Y city. Here, each number in parenthesis in the drawing represents the number of search results for POIs at an end point of the link. More specifically, in the X city, the search range is set to be larger than that in the Y city, and thus the number of search results is large. To the contrary, in the Y city, the search range is set to be smaller than that in the X city, and thus the number of search results is small

A search for POIs may be performed for each reference location or may be performed for each link. In a case in which a search for each reference location is performed, the search device 200 searches for map information with a new search range set every time when the reference location changes. For example, in this case, when the reference location is set to the current location of a user, a search result changes at every moment in accordance with movement of the user.

On the other hand, in a case in which a search is performed for each link, the search device 200 sets all the places on the link as reference locations and searches map information in a range from all the reference locations to a distance according to a preference score of the target user for an administrative district having the link as the search range. For example, in a case in which a movement path formed from the links R1 to R5 illustrated in FIG. 9 is proposed to a user, the search device 200 may simultaneously perform a search for all the search ranges SR11 to SR15 determined for each link. By configuring as such, a user can simultaneously perform a search for POIs present near a path from a start place to a destination for planned movement.

In addition, for example, the search device 200 may perform a search for a search range determined for a link including the current location of the user. In this case, for example, in the example illustrated in FIG. 9, when a user is moving in the link R1, the search device 200 performs a search of map information for the search range SR11 and, in a case in which the user passes through the link R1 and enters the link R2, changes the search range from SR11 to SR12 and performs a search of map information. In other words, in this case, in the user terminal 100, when the user is moving in the link R1, a search result for the search range SR11 is displayed, and, when the user is moving in the link R2, a search result for the search range SR12 is displayed. For this reason, in this case, the search device 200 may monitor the current location of a user on the basis of location information acquired from the user terminal 100 and perform a search at a timing at which the link in which the user is moving is changed.

When such a POI search result is provided for a user, the user can acquire more search results of desired POIs for an administrative district matching his or her preference and can acquire less search results for an administrative district not matching his or her preference.

### MODIFIED EXAMPLE

The search device 200 according to an embodiment may be configured as a part of a navigation device performing path guiding on the basis of map information. In such a case, the navigation device including the search device 200 continuously acquires location information of the user terminal 100 using the acquirer 221 until a user arrives at a destination from a start place and switches the display range of the map in accordance with the movement of the user such that a map of an area in a traveling direction from the current location of the user is displayed inside a screen of the display. In addition, together with the switching of the display range, the search device 200 performs a search of map information in a search range based on the preference of the user and displays extracted POIs on the map.

For example, in this case, the search device 200 searches map information with a range that has a place on a link composing a path (movement path) guiding the user as its center and is based on the preference of the user for a district including the link set as a search range and displays a result of the search (hereinafter, referred to as a “first search result”) on a map representing the movement path of the user. In this case, the search device 200 may search map information with a range that has the current location of the user or a specific location designated by the user as its center and is based on the preference of the user for the current location or the specific location set as a search range and display a result of the search (hereinafter, referred to as a “second search result”) on a map representing the current location of the user or the specific location.

In addition, the search device 200 may simultaneously display both the first search result and the second search result on the map.

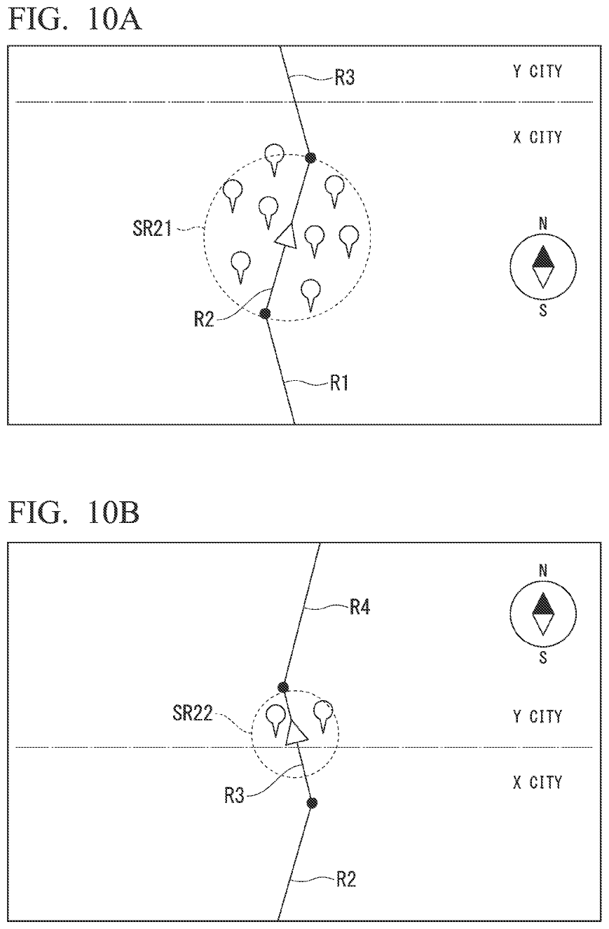

FIGS. 10A and 10B are diagrams illustrating examples of a transition of a screen display when the search device 200 according to the modified example displays a search result of map information while guiding the path. Here, for simplification, a case in which the search device 200 guides the path illustrated in FIG. 9 and performs a search of map information in a search range according to the current location of the user will be described. More specifically, FIG. 10A illustrates a display example when the user is moving in the link R2, and FIG. 10B illustrates a display example when the user is moving in the link R3 after passing through the link R2. In each diagram, a broken line represents a search range at each timing. In this example, when the user is moving in the X city having a higher preference score than the Y city, by searching map information in the range of the search range SR21 that is relatively large, the search device 200 displays relatively many POIs on the map as a result of the search. On the other hand, when the user leaves the X city and is moving in the Y city, by searching map information in the range of the search range SR22 that is relatively small, the search device 200 displays relatively few POIs on the map as a result of the search.

The embodiment described above can be expressed as below.

A search device including: a storage device storing a program; and a hardware processor, in which, by executing the program stored in the storage device, the hardware processor is configured to acquire a request for searching for places and search for places on a map in a search range based on the preference of a user for places relating to the search request described above.

As above, although a form for performing the present invention has been described using the embodiment, the present invention is not limited to such an embodiment at all, and various modifications and substitutions can be made in a range not departing from the concept of the present invention.

What is claimed is:

1. A search device comprising:
an acquirer configured to acquire a search request for searching for a place; and
a searcher configured to search for a place on a map in a search range based on a preference of a user for the place relating to the search request.

2. The search device according to claim 1,
wherein the place relating to the search request is a place on a movement path set by the user, and
wherein the search range is a range that has a place on a link configuring the movement path as its center and is based on a preference of the user for a district including the link.

3. The search device according to claim 1,
wherein the place relating to the search request is a current location of the user or a specific location designated by the user, and
wherein the search range is a range that has the current location or the specific location as its center and is based on a preference of the user for the current location or the specific location.

4. The search device according to claim 1, further comprising a score information generator configured to generate score information that indicates a strength of the preference of the user for an administrative district on the basis of a relationship between a place represented on a map and the administrative district,
wherein the searcher acquires the strength of the preference of the user for the administrative district having a target place relating to the search request on the basis of the score information and searches for the place on the map in the range of a search range that is a search range including the target place and has an area according to the strength of the preference.

5. The search device according to claim 4, wherein the score information generator analyzes the preference target of the user on the basis of a reviewing result of the preference for the user or behaviors performed by the user in the past and acquires the strength of the preference of the user for the administrative district on the basis of the relationship between the analyzed preference target and the administrative district.

6. The search device according to claim 4, wherein the searcher determines the search range on the basis of a first distance for setting a range that serves as a reference of the search range and a second distance for extending the range serving as the reference in accordance with the strength of the preferences.

7. The search device according to claim 6, wherein the searcher searches for a place on the map with a range to a distance acquired by summing the first distance and the second distance from the target place set as the search range.

8. The search device according to claim 4, wherein the searcher extracts a place coinciding with a search condition relating to the search request in the search range among places represented on the map.

9. The search device according to claim 4, wherein the score information generator determines a preference score of the user for an administrative district on the basis of nodes or edges passed through until a node corresponding to a certain administrative district is reached using the preference target of the user as a start point node in a graph structure representing a relationship between the preference target of the user and the administrative district.

10. A search method using a computer, the search method comprising:
acquiring a search request for searching for a place; and
searching for a place on a map in a search range based on a preference of a user for the place relating to the search request.

11. A computer-readable non-transitory storage medium having a program stored thereon, the program causing a computer to execute:
acquiring a search request for searching for a place; and
searching for a place on a map in a search range based on a preference of a user for the place relating to the search request.
